(19) United States
(12) Patent Application Publication
(10) Pub. No.: US 2026/0342724 A1
(43) Pub. Date: Oct. 29, 2026

(54) HARDWARE OFFLOAD FOR TRANSMIT PROCESSING OF PACKETS

(71) Applicant: Arista Networks, Inc., Santa Clara, CA (US)

(72) Inventors: Michael Chih-Yen Wang, Vancouver (CA); Navdeep Bhatia, Mountain View, CA (US); Dileep Ramesh, Sunnyvale, CA (US); Timur Cheremisov, San Jose, CA (US)

(21) Appl. No.: 19/680,538

(22) Filed: May 18, 2026

Related U.S. Application Data
(63) Continuation of application No. 18/620,865, filed on Mar. 28, 2024, now Pat. No. 12,652,242.

(51) Int. Cl. H04L 45/00; H04L 45/586

(52) U.S. Cl. CPC H04L 45/566; H04L 45/586

(57) ABSTRACT

A software agent generates packet sessions and hands off the task of generating and routing the packets to a programmable hardware logic block, such as a packet processor. The software agent provides entries in one or more tables that are subsequently used by the packet processor to generate and route the packets. During a first stage, the packets are generated at an ingress pipeline. The packets are then transferred to an egress pipeline from which pipeline the packets are reinjected back into the ingress pipeline. During the second stage and at the ingress pipeline, routing information, representative of a network layer or a tunnel, to which the packets are to be routed, are added to the packets. The packets are then forwarded to the egress pipeline and subsequently routed to a next hop or tunnel leading to the packets’ respective destination addresses.

### CROSS-REFERENCE TO RELATED APPLICATIONS

This application is a continuation of U.S. non-provisional patent application No. 18/620,865, filed Mar. 28, 2024, which is hereby incorporated by reference herein in its entirety.

### TECHNICAL FIELD

The present application relates to communication/data networks, and more particularly to formation and transmission of packets by a network device connected to such networks.

### BACKGROUND

The need for packet formation and transmission at ever increasing rates continues to rise. Conventional software-based techniques are not suitable for processing of packets at such high rates, resulting in bottlenecks, and inefficiencies.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 is a high level block diagram of a pair of network devices that are in communication with one another via a network.

FIG. 2 shows more details of the network devices of FIG. 1.

FIG. 3 shows a number of logic blocks of a packet processor configured to form and transmit packets, in accordance with one embodiment of the present disclosure.

FIGS. 4A, 4B and 4C show a number of tables used in forming and transmitting packets, in accordance with one embodiment of the present disclosure.

FIG. 5 is a flowchart for generating and routing BFD packets, in accordance with one exemplary embodiment of the present disclosure.

FIG. 6 is a flowchart for generating and routing BFD packets, as performed by a programmable hardware logic block, in accordance with one exemplary embodiment of the present disclosure.

### DETAILED DESCRIPTION

Conventionally, packet sessions, including the generation and routing of packets, such as bidirectional forwarding detection (BFD) packets, are generated either in software using a central processing unit, or by using a specialized hardware such as a co-processor. Neither of the conventional techniques is able to handle packet sessions at relatively large scale and exceeding, for example 2000 BFD packet sessions.

In accordance with one embodiment of the present disclosure, a software agent(s) generates the BFD packet sessions and hands off the process of packet generation and routing to a hardware logic block, such as a packet processor. The software agent(s) also provides entries in one or more tables formed in a memory of the packet processor. The packet processor generates the packets using the entries in the tables and subsequently routes the packets.

In one embodiment, the packet generation and routing are carried out in two stages. During the first stage, in conformity with a networking protocol, the packets are formed at an ingress pipeline of a packet processor and transferred to an egress pipeline of the packet processor. The packets are then reinjected back into the ingress pipeline via a recirculation logic coupled between the ingress and egress pipelines. At the ingress pipeline and during the second stage, header information, representative of a network layer or a tunnel to which the packets are to be routed, are added to the packets. The packets are then forwarded to the egress pipeline from which the packets are routed to their destination following a route lookup process.

By forming and reinjecting the packets back into the ingress pipeline prior to the packets’ route lookup, the packet formation stage is therefore decoupled from the packet routing stage. Embodiments of the present disclosure enable packet sessions that are substantially higher in number than the number of sessions supported by existing software-based techniques. The decoupling further enables the packet sessions to be carried out in both underlay (regular session) as well as overlay (packets going in a tunnel) with relatively small amount of information exchanged between the BFD agent handling the sessions and the platform agent. It is understood that the BFD agent refers to a software module/agent that, among other functions, (i) runs on the control plane, as described further below, (ii) generates the BFD sessions and (iii) hands off the task of BFD packet formation and routing to the packet processor. The platform agent, which is also a software module/agent running on the control plane, among other functions, (i) receives data associated with the BFD packets from the BFD agent and (ii) programs a memory, disposed in the packet processor, to include one or more lookup tables to store such data.

Embodiments of the present disclosure further enable packet generation (formation) and routing (transmission) to be migrated from a software platform to a hardware platform (such as a packet processor) and back. For example, if the BFD agent sends a notification to offload the process of packet formation and transmission to a packet processor, and the platform agent is unable to offload that session for any reason, then the platform agent can notify the BFD agent accordingly so that the BFD agent can perform the required tasks in software.

Moreover, because the BFD packet formation is decoupled from the packet routing, when there are problems related to, for example, routing convergence or tunnel change, only a subset of parameters need to be changed. Therefore, changes in the next hop along the destination or the tunnel advantageously will not trigger any update from BFD agent to the platform agent, as is required by existing systems. In accordance with the present disclosure, once a session is established, only a change in any of the BFD header parameters needs to be communicated from the BFD agent to the platform agent. Embodiments of the present disclosure enable both single hop and multi-hop sessions which may be carried out on any layer-3 interface, such as routed interface, VLAN interface, port-channel interface, and the like.

The following description of the embodiments of the present disclosure are described with reference to forming and transmitting BFD packets. It is understood, however, that embodiments of the present disclosure are not so limited and equally apply to any other type of packets. As is known, BFD packets are used to monitor the status of a network connection and determine whether the network connection is active.

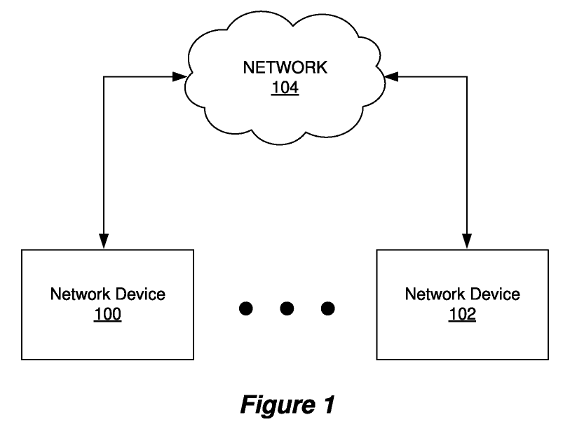

FIG. 1 is a high level block diagram of a pair of network devices 100 and 102 that are connected to one another via network 104. Each of network devices 100 and 102 includes a processor, a memory, as well as communications/networking circuitry. Network devices 100 and 102 may be a network switch, a router, a multilayer switch, a fiber channel device, an InfiniBand® device, and the like. Network 104 may be a local area network (LAN), a wide area network (WAN) (e.g., the Internet), a mobile network, or any other type of network that enables transfer of information between the network devices that are connected thereto, such as network devices 100 and 102.

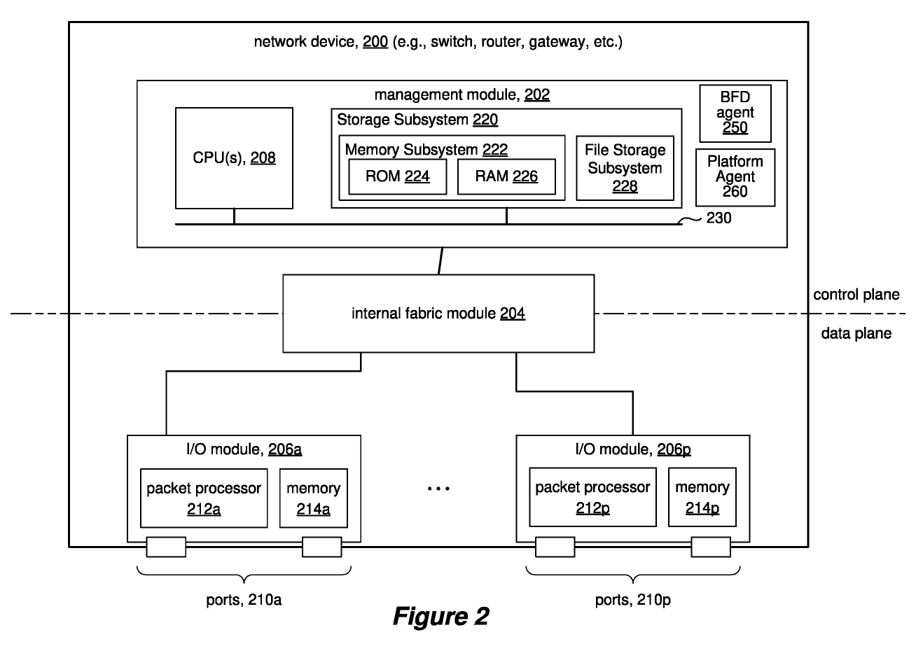

FIG. 2 is a schematic diagram of a network device (e.g., switch, router, etc.) that may be used in accordance with the present disclosure and that corresponds to network devices 100 and 102 of FIG. 1. Network device 600 is shown as including a management module 202, an internal fabric module 204, and a number of I/O modules 206a – 206p.

Management module 202 may form the control plane (also referred to as control layer or simply the CPU) of network device 200 and can include one or more management CPUs 208 for managing and controlling operation of network device 200 in accordance with the present disclosure. Each management CPU 208 may be a general-purpose processor, such as an Intel®/AMD® x86, ARM® microprocessor and the like, that operates under the control of software stored in a memory, such as ROM (read-only memory) 224 or RAM (random-access memory) 226. The control plane provides services that include traffic management functions such as routing, security, load balancing, analysis, and the like. In some examples, one or more management CPUs 208 may be configured to perform some or all of the methods disclosed herein, for example according to software stored in the ROM 224 and/or the RAM 226.

Management module 202 is also shown as including, in part, a BFD agent 250 and a platform agent 260. BFD agent 250 and platform agent 260 are software modules/agents that run on the control plane. BFD agent 250 generates the BFD sessions and hands off the task of packet formation and routing to one or more packet processors 212a-212p disposed respectively in I/O modules 206a-206p via platform agent 260. Platform agent 260 receives data associated with the BFD packets from BFD agent 250 and programs one or more of memories 214a-214p, also disposed in I/O modules 206a-206p, to include one or more lookup tables to store the data associated with the packets.

Management module 202 includes one or more management CPUs 208 that communicate with storage subsystem 220 via bus subsystem 230. Other subsystems, such as a network interface subsystem (not shown in FIG. 2), may be on bus subsystem 230. Storage subsystem 220 may include memory subsystem 222 and non-volatile storage subsystem 228. Storage subsystem 120 represents an example of non-transitory computer-readable storage media that can store program code and/or data, which when executed by one or more management CPUs 208, can cause one or more management CPUs 208 to perform operations in accordance with embodiments of the present disclosure.

Memory subsystem 222 may include a number of memories including main RAM 226 for storage of instructions and data during program execution and ROM (read-only memory) 224 in which fixed instructions and data are stored. Storage subsystem 228 can provide persistent (i.e., non-volatile) storage for program and data files, and can include various types of storage media known in the art such as solid-state drives, hard-disk drives, and so on.

One or more management CPUs 208 may run a network operating system stored in storage subsystem 220. A network operating system is a specialized operating system for network device 200 (e.g., a router, switch, firewall, and the like). For example, the network operating system may be Arista Extensible Operating System (EOS®), which is a fully programmable and highly modular, Linux-based network operating system. Other network operating systems may be used.

Bus subsystem 230 may provide a mechanism for enabling the various components and subsystems of management module 202 communicate with each other. Although bus subsystem 230 is shown schematically as a single bus, alternative embodiments of the bus subsystem can utilize multiple buses.

Internal fabric module 204 and I/O modules 206a – 206p collectively represent the data plane of network device 200 (also referred to as data layer, forwarding plane, etc.). Internal fabric module 204 represents interconnections among the various other modules of network device 200. Each I/O module 206a – 206p can include one or more input/output (ingress/egress) ports 210a – 210p that are used by network device 200 to receive and forward network traffic. Each I/O module 206a – 206p can also include packet processing capability, logically represented by respective packet processors 212a – 212p and memory components 214a – 214p. Packet processors 212a – 212p may include, in part, forwarding hardware, including for example, data processing elements such as an ASIC (application specific integrated circuit), FPGA (field programmable array), digital processing unit, and the like. Memory components 214a – 214p may include lookup hardware, including for example, content addressable memory such as TCAMs (ternary CAMs) and auxiliary memory such as SRAMs (static random access memory). The forwarding hardware in conjunction with the lookup hardware may provide instructions on how to process ingress packets and outgoing packets for egress. In accordance with some embodiments, a number of aspects of the present disclosure may be performed within the data plane.

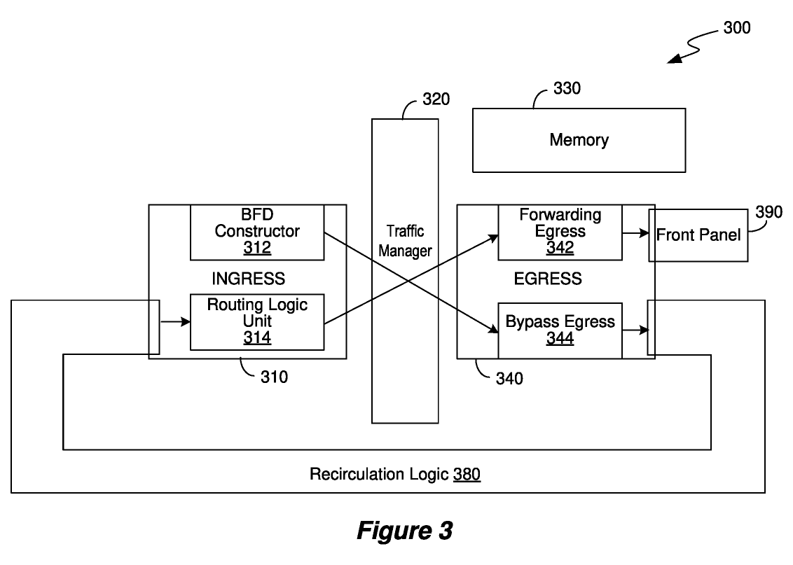

FIG. 3 shows a number of components of a programmable hardware logic block 300, in accordance with one embodiment of the present disclosure. Programmable hardware logic block 300, which may be a packet processor corresponding to any of the packer processors 212a-212p shown in FIG. 2, may be a programmable Ethernet switch with components that are integrated on one or more silicon substrates.

Programmable hardware logic block 300 (alternatively referred to hereinafter as packet processor) is shown as including, in part, an ingress pipeline 310, an egress pipeline 340, a traffic manager 320, a recirculation logic 380, and a memory 330. Ingress pipeline 310 is shown as including, in part, a BFD packet constructor (alternatively referred to herein as packet construction unit) 312 and a routing logic unit 314. Egress pipeline 340 is shown as including, in part, a first egress block 344 that is also referred to herein as bypass egress block, and a second egress block 342 also referred to herein as forwarding egress block. Ingress pipeline 310 is shown as being in communications with egress pipeline 340 via recirculation logic 380. Forwarding egress block 342 is shown as being coupled to a front panel 390 of the egress pipeline 340.

BFD packet constructor 312 is configured to generate the BFD packets, using data stored by the platform agent in one or more lookup tables in memory 330, and transfer the BFD packets to bypass egress block 344 via traffic manager 320. Routing logic unit 314 is configured, in part, to receive the BFD packets reinjected into the recirculation logic 380 by bypass egress block 344, add header and any other forwarding information that may be required to route the BFD packets (alternatively referred to as outgoing packet), and forward the packets to forwarding egress block 342. Traffic manager 320 is configured to control the transfer of packets from ingress pipeline 310 to egress pipeline 340. Forwarding egress block 342 is configured, in part, to forward the packets received from routing logic unit 314 to the next hop along the destination of the BFD packets via front panel 390.

In accordance with embodiments of the present disclosure, the BFD agent, as described above with reference to FIG. 2, generates the BFD sessions and hands off the task of packet formation and routing to packet processor 300. The BFD agent also delivers data associated with the BFD packets to the platform agent, also described above with reference to FIG. 2. In response, the BFD platform programs memory 330 to include one or more lookup tables and stores the data associated with the BFD packets in the lookup tables. BFD packet constructor 312 is configured to generate the BFD packets using the lookup tables included in memory 330..

The BFD packets are formed and transmitted at a user-configurable time interval for each BFD session. In one example, the BFD packets are formed and transmitted during every 300 msec time interval for each BFD session. However, the time interval for forming and transmitting BFD packets may be changed by the user. In one example, the number of BFD sessions that packet processor 300 may support is 32,728 (2¹⁵) sessions. However, packet processor 300 may be programmed to support any number of BFD sessions, limited only by the amount of the memory, such as SRAM, available to store the BFD session.

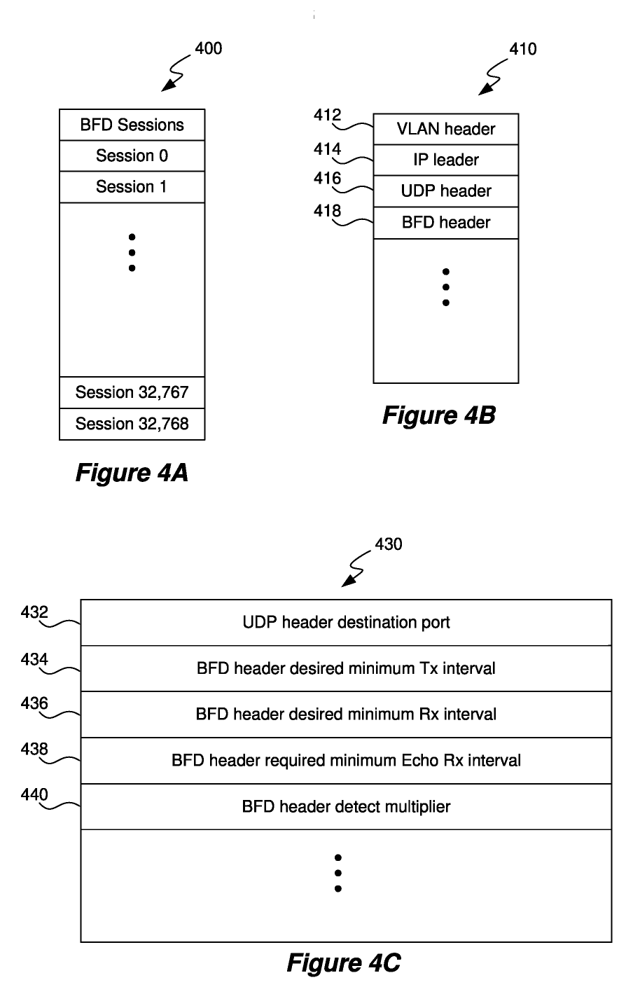

As was described above, in accordance with a first aspect of the present disclosure, the BFD packets are formed during the first stage. FIG. 4A shows an example of a table 400 that is populated with BFD session numbers with which the BFD packets are associated. Therefore, when a BFD session starts, an entry is added to table 400 to identify the BFD session number of the associated BFD packets. Exemplary table 400 is shown as including 2¹⁵ entries thus supporting 2¹⁵ distinct BFD sessions.

Referring to FIGS. 3 and 4A concurrently, for each session that has an entry in table 400, packet constructor 312 uses one or more tables (that may be stored in memory 330) to generate a BFD packet during the user-configurable time interval (e.g., 300 msec) and inject the generated packet from ingress pipeline 310 to egress pipeline 340. For example, assume table 400 has been populated with 1000 BFD sessions. Therefore, during each, e.g. 300 msec, a BFD packet is generated for each of the 1000 sessions of table 400 and injected into (i.e., transferred to) egress pipeline 340.

FIG. 4B shows a Table 410 containing a set of exemplary parameters that get included in each BFD packet during the first stage. As shown, each BFD packet is populated with a virtual local area network (VLAN) header 412, an internet protocol (IP) header 414, a user datagram protocol (UDP) header 416, a BFD packet header 418, and the like. Table 410 may include additional parameters, such as BFD header length, BFD version, and the like, that are not shown for simplicity. The information in Table 410 is provided by the platform agent, which in turn, receives this information from the BFD agent.

FIG. 4C shows a table 430 that may also be used in generating the BFD packets during the first stage. Table 430 is shown as including a number of entries such as UDP header destination port 432, BFD header desired minimum TX interval 434, BFD header desired minimum RX interval 436, BFD header required minimum Echo RX interval 438, and BFD header detect multiplier 440, each of which entries may be 32 bits in one example. Table 430 is pointed to by a profile table (not shown) that is also stored in memory 330 of packet processor 300.

In one embodiment, to minimize hardware usage, each BFD session is assigned a profile identifier (ID) that is stored in the profile table. The profile ID, which may be a 16-bit number in one example, points to a set of corresponding entries in table 430. Accordingly, the entries in table 430 that are the same for different BFD sessions are pointed to by the profile ID of all such BFD sessions, thereby dispensing the need to store the same entries for each such BFD session separately. For example, if all the sessions in table 400 have the same session interval of 300 msec, all BFD sessions are assigned the same profile ID pointing to the same entries in table 430. Although the above description of BFD packet formation is made with reference to tables 400, 410 and 430, it is understood that embodiments of the present disclosure are not so limited, and that a BFD packet may be formed using any number of tables, e.g., one, two or otherwise. Moreover, such tables may be stored in the same or different memory spaces.

A BFD packet formed during the first stage is subsequently transferred from BFD constructor 312 to bypass egress block 344 by traffic manager 320. Thereafter, the packet is transferred via the recirculation logic 380 to routing logic unit 314, where the packet undergoes a routing lookup.

As described above, the BFD packets formed during the first stage may include, among other parameters, a VLAN header, an IP header, an Ethernet header, a UDP header, and a BFD header. When a BFD packet is received at routing logic unit 314, the packet’s VLAN ID is retrieved from the VLAN header. The VLAN ID is then used to look up a virtual routing and forwarding (VRF) ID in a table (not shown) that may also be stored in memory 330. Each VRF ID corresponds to a routing table. The VRF ID together with the destination IP of the packet uniquely identify the next hop from the routing table to which the packet is to be routed. The BFD packet is therefore modified to include the header and any other forwarding information that may be required to route the modified packet (alternatively referred to as outgoing packet) to its final destination.

The next hop along the destination of a packet may either be a regular hop pointing to an egress interface, or may be a tunnel which will require the packet to undergo a virtual extensible LAN (VXLAN), a generic routing encapsulation (GRE), an IP-in-IP encapsulation, and the like. By decoupling the packet formation from the packet routing, as described in detail above, all Layer-2 network and Layer-3 network attributes/features become available for routing of the outgoing packets. Such decoupling further enables the BFD session to be carried out both in the underlay and/or the overlay. Moreover, because only the attributes required in forming the BFD packets and their destination information are communicated to the platform agent, the amount of information that is transmitted from the control plane to the platform agent is relatively small, thus enabling the packet formation and transmission to be carried out at relatively high scale and high speeds.

Embodiments of the present disclosure further enable packet formation and transmission to be migrated from a software platform to a hardware platform (such as packet processor 300 described above) and back. For example, if the BFD agent sends a session to the platform agent to offload the process of packet formation and transmission to, e.g. packet processor 300, and the platform agent is unable to offload that session for any reason, then the platform agent can notify the BFD agent accordingly so that the BFD agent can perform the required tasks in software.

Moreover, because the BFD packet formation is decoupled from packet routing, when there are problems related to, for example, routing convergence or tunnel change, only a subset of parameters need to be changed. Therefore, changes in the next hop along the destination or the tunnel advantageously will not trigger any update from BFD agent to the platform agent, as is required by existing systems. In accordance with the present disclosure, once a session is established, only a change in any of the BFD header parameters needs to be communicated from the BFD agent to the platform agent. Moreover, embodiments of the present disclosure enables both single hop and multi-hop BFD sessions which may be carried out on any Layer-3 interface, such as routed interface, VLAN interface, port-channel interface, and the like.

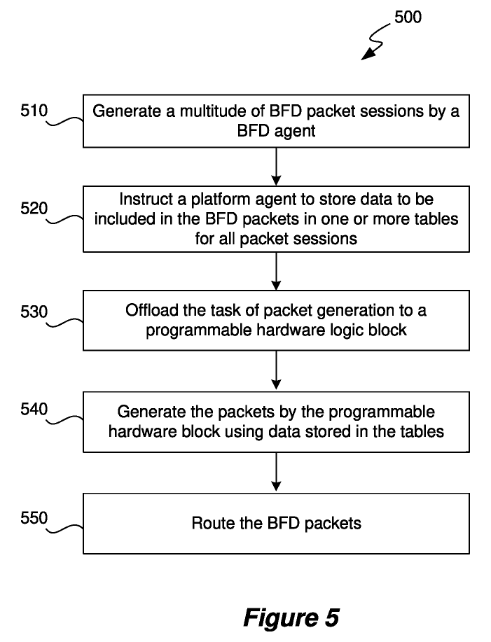

FIG. 5 is a flowchart 500 for generating and routing BFD packets, in accordance with one exemplary embodiment of the present disclosure. At 510, a BFD software agent generates a multitude of BFD packet sessions. At 520, the BFD software agent instructs a platform software agent to store data to be included in the BFD packets in one or more lookup tables for all packet sessions. At 530, the BFD software agent instructs the platform agent to offload the task of BFD packet generation and routing to a programmable hardware logic block, such as a packet processor. At 540, the programmable hardware logic block generates the BFD packets using the data stored in the one or more lookup tables. At 550, the programmable hardware logic block routes the generated BFD packets.

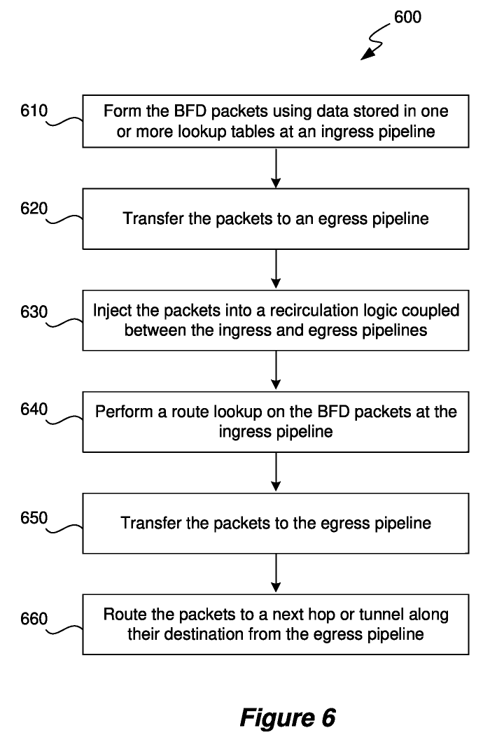

FIG. 6 is a flowchart 600 for generating and routing BFD packets, as performed by a programmable hardware logic block, such as a packet processor, in accordance with one exemplary embodiment of the present disclosure. At 610, the BFD packets are formed at an ingress pipeline using data stored in one or more lookup table. At 620, the BFD packets are transferred from the ingress pipeline to the egress pipeline. At 630, the BFD packets are injected into a recirculation logic coupled between the egress pipeline and the ingress pipeline. At 640, a route lookup is performed at the ingress pipeline for each BFD packet injected into the recirculation logic. At 650, the BFD packets are transferred to the egress pipeline. At 660, each BFD packet is routed to a next hop or tunnel along the packet’s destination address.

The above description illustrates various embodiments of the present disclosure together with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A network device comprising:
one or more memories;
a central processing unit communicatively coupled to the one or more memories and forming a control plane of the network device; and
a packet processor having a memory and forming a forwarding plane of the network device,
wherein the central processing unit is configured to:
generate a session for which a plurality of packets are to be transmitted by the network device; and
program the memory of the packet processor to store data in one or more lookup tables for generating each packet in the plurality of packets for the session, and
wherein the packet processor is configured to:
generate each packet in the plurality of packets for the session using the data in the one or more lookup tables stored in the memory of the packet processor; and
transmit each packet in the generated plurality of packets for the session to a next hop.

2. The network device defined in claim 1, wherein the session generated by the central processing unit is a bidirectional forwarding detection (BFD) session and wherein the plurality of packets generated and forwarded by the packet processor are BFD packets.

3. The network device defined in claim 2, wherein the BFD packets are usable to monitor a status of a network connection.

4. The network device defined in claim 1, wherein the plurality of packets for the session are periodically generated by the packet processor according to a time interval for the session.

5. The network device defined in claim 4, wherein the time interval is a user-configurable time interval.

6. The network device defined in claim 4, wherein the session is identified by a corresponding entry added to a table at a start of the session and wherein the plurality of packets for the session are periodically generated by the packet processor according to the time interval for the session based on the entry in the table.

7. The network device defined in claim 1, wherein the data programmed by the central processing unit and stored in the one or more lookup tables in the memory of the packet processor comprises header information for the plurality of packets for the session and wherein each packet in the plurality of packets for the session is generated by the packet processor by including the header information in each packet in the plurality of packets for the session.

8. The network device defined in claim 7, wherein the header information comprises information in at least one of a virtual local area network (VLAN) header, an internet protocol (IP) header, a user datagram protocol (UDP) header, or a bidirectional forwarding detection (BFD) header.

9. The network device defined in claim 1, wherein the session is assigned a profile identifier stored in a profile table stored in the memory of the packet processor, wherein the profile identifier references a set of information, and wherein each packet in the plurality of packets for the session is generated using the set of information referenced by the profile identifier.

10. The network device defined in claim 9, wherein the set of information referenced by the profile identifier comprises at least one of a user datagram protocol (UDP) header destination port, a bidirectional forwarding detection (BFD) header desired minimum transmission interval, a BFD header desired minimum reception interval, a BFD header required minimum echo reception interval, or a BFD header detect multiplier.

11. The network device defined in claim 9, wherein the central processing unit is configured to generate an additional session for which an additional plurality of packets are to be transmitted by the network device and to program the memory of the packet processor to store additional data in the one or more lookup tables for generating each packet in the additional plurality of packets for the additional session, wherein the packet processor is configured to generate each packet in the additional plurality of packets for the additional session using the additional data in the one or more lookup tables stored in the memory of the packet processor, wherein the additional session is assigned an additional profile identifier stored in the profile table stored in the memory of the packet processor, wherein the additional profile identifier references an additional set of information, wherein the additional set of information and the set of information contain some same information, and wherein each packet in the additional plurality of packets for the additional session is generated using the additional set of information referenced by the additional profile identifier.

12. The network device defined in claim 1, wherein the packet processor is configured to provide each packet in the generated plurality of packets from an egress pipeline of the packet processor to an ingress pipeline of the packet processor prior to transmitting each packet in the generated plurality of packets to the next hop.

13. The network device defined in claim 12, wherein the packet processor is configured to add, after providing each packet in the generated plurality of packets from the egress pipeline to the ingress pipeline, forwarding information to each packet in the generated plurality of packets prior to transmitting each packet in the generated plurality of packets to the next hop.

14. The network device defined in claim 13, wherein the forwarding information is added to each packet in the generated plurality of packets based on a route lookup performed by the packet processor.

15. The network device defined in claim 14, wherein each packet in the plurality of packets is generated at the ingress pipeline, wherein each packet in the plurality of packets generated at the ingress pipeline is provided to the egress pipeline prior to being provided back to the ingress pipeline from the egress pipeline, wherein the route lookup is performed at the ingress pipeline, wherein the forwarding information is added to each packet in the generated plurality of packets at the ingress pipeline, and wherein each packet in the generated plurality of packets is transmitted to the next hop from the egress pipeline.

16. A method of providing a plurality of bidirectional forwarding detection (BFD) packets, the method comprising:
generating, by a BFD software agent, a session during which the plurality of BFD packets are transmitted;
providing, by the BFD software agent, one or more instructions to use a programmable hardware logic block to generate the plurality of BFD packets;
providing, by the BFD software agent, one or more instructions to store data associated with the plurality of BFD packets in one or more lookup tables in a memory of the programmable hardware logic block;
generating, by the programmable hardware logic block, the plurality of BFD packets using the data stored in the one or more lookup tables in the memory of the programmable hardware logic block and provided by the BFD software agent; and
routing, by the programmable hardware logic block, the generated plurality of BFD packets to a hop or tunnel leading to respective destination addresses of the generated plurality of BFD packets.

17. The method defined in claim 16, wherein the BFD software agent is provided as part of a control plane of a network device implemented using a central processing unit and wherein the programmable hardware logic block forms a forwarding plane of the network device.

18. The method defined in claim 17, wherein the one or more instructions to use the programmable hardware logic block to generate the plurality of BFD packets and the one or more instructions to store the data associated with the plurality of BFD packets in the one or more lookup tables in the memory of the programmable hardware logic block are provided to a platform agent communicatively coupled to the programmable hardware logic block and wherein the platform agent is provided as part of the control plane of the network device implemented using the central processing unit.

19. A network device comprising:
a packet processor configured to:
receive, from a central processing unit, instructions
to store data associated with a bidirectional forwarding detection (BFD) packet in one or more tables on a memory of the packet processor, wherein the central processing unit is configured to generate a session for the BFD packet and maintain a session identification of the BFD packet, and
to generate the BFD packet;
generate, at an ingress pipeline of the packet processor, the BFD packet by including header information in the BFD packet using the data stored in the one or more tables in accordance with the instructions received from the central processing unit;
provide the generated BFD packet from the ingress pipeline to an egress pipeline of the packet processor;
inject the BFD packet from the egress pipeline back into the ingress pipeline;
add, at the ingress pipeline, forwarding information to the BFD packet after being injected back into the ingress pipeline; and
transmit the BFD packet with the added forwarding information to a hop or tunnel leading to a destination address of the generated BFD packet.

20. The network device defined in claim 19, wherein the packet processor is configured to generate additional BFD packets for the session by including respective header information in each of the additional BFD packets using the data stored in the one or more tables.
